(19) United States
(12) Patent Application Publication
(10) Pub. No.: US 2012/0154958 A1
(43) Pub. Date: Jun. 21, 2012

(54) USE OF A JFET AS A FAILSAFE SHUTDOWN CONTROLLER

(75) Inventor: Lon Schneider, Centennial, CO (US)

(73) Assignee: Nexergy, Inc., Columbus, OH (US)

(21) Appl. No.: 12/973,341

(22) Filed: Dec. 20, 2010

(51) Int. Cl. H02H 9/00

(52) U.S. Cl. 361/18

(57) ABSTRACT

Various embodiments disclose methods and systems for controlling operation of a regulator controller integrated circuit. The regulator controller integrated circuit may include a run input and a voltage supply input. A voltage supply, having an on state and an off state, may be coupled with the voltage supply input of the regulator controller integrated circuit. A JFET that has a source, a drain, and a gate may be present. The source of the JFET may be coupled with electrical ground. The drain of the JFET may be coupled with the run input of the regulator controller integrated circuit. The gate of the JFET may be coupled with the voltage supply. Such embodiments may disable a regulator unless a supply voltage is present without requiring a supply voltage for control circuitry.

### CROSS REFERENCES

This application is related to U.S. patent application Ser. No. ______, entitled “Two-Way Switching Regulator,” Attorney Docket Number 040328-000500US, filed on Dec. 20, 2010, the entire disclosure of which is hereby incorporated by reference for all purposes.

### BACKGROUND OF THE INVENTION

1. Field of Invention

The present invention relates to the field of regulator controllers (e.g., regulators). An embodiment of the present invention relates to using a Junction FET, or depletion mode FET, referred to as a JFET to enable a regulator controller circuit. Specifically, one embodiment of the invention uses a JFET to enable and disable a regulator controller depending on whether a voltage, supplied by an external source, is present.

2. Background of the Invention

Circuits, such as switching regulator controllers (referred to as regulator controllers), may be useful to convert an input voltage to a different output voltage. In order to prevent possible damage to a regulator controller, its associated circuitry, and/or components coupled with the regulator controller, it may be necessary to ensure that the regulator controller is disabled when the supply voltage to the regulator controller (or some other supply voltage) is not present. Similarly, when the supply voltage is present, it may be desired that the regulator controller be enabled. In order to allow for such control of the regulator controller, the regulator controller may have an input that enables and disables the regulator controller. Through adjustment of this input, the regulator controller may be enabled or disabled. While circuits exist that may create a signal to control operation of the regulator controller, these circuits may only operate when some supply voltage is present, may be large, requiring a substantial amount of circuit board space, may be power hungry, and/or may, if certain conditions are present, enable or disable the regulator controller at improper times.

### BRIEF SUMMARY OF THE INVENTION

Various embodiments disclose methods and systems for controlling operation of a regulator controller integrated circuit. The regulator controller integrated circuit may include a run input and a voltage supply input. A voltage supply, such as a battery or an external supply, having an on state and an off state, may be coupled with the voltage supply input of the regulator controller integrated circuit. A JFET, which has a source, a drain, and a gate may be present. The source of the JFET may be coupled with electrical ground. The drain of the JFET may be coupled with the run input of the regulator controller integrated circuit. The gate of the JFET may be coupled with the voltage supply. Based on whether the voltage supply is absent or not, the JFET may disable the regulator controller from false activation even in the absence of other controls, or absence of a supply voltage to operate other controls.

In some embodiments, a system for controlling operation of a regulator controller integrated circuit may be present. The system may include the regulator controller integrated circuit comprising a run input and a voltage supply input. The system may include a voltage supply. The voltage supply may have an on state and an off state. The voltage supply may be coupled with the voltage supply input of the regulator controller integrated circuit. The system may include a JFET, comprising: a source, a drain and a gate. The source of the JFET may be coupled with electrical ground. The drain of the JFET may be coupled with the run input of the regulator controller integrated circuit. The gate of the JFET may be coupled with the voltage supply.

In some embodiments, the regulator controller integrated circuit is enabled when the run input is floating. The regulator controller integrated circuit may be disabled when the run input is coupled with electrical ground. In some embodiments, the JFET may be further configured such that the JFET connects the run input of the regulator controller integrated circuit to electrical ground when the voltage supply is in the off state. The regulator controller integrated circuit, may be a switching regulator controller integrated circuit. In some embodiments, the system further comprising a soft start circuit coupled with the run input of the regulator controller integrated circuit. The JFET may decouple a current path from the run input of the regulator controller integrated circuit to electrical ground when the voltage supply is in the on state. The regulator controller integrated circuit may comprise a current source pull-up coupled with the run input. In some embodiments, the JFET is a p-channel JFET. In some embodiments, the JFET is an n-channel JFET, electrical ground is positive, and the voltage supply supplies a negative voltage.

In some embodiments, a method for controlling operation of a regulator controller integrated circuit having a run input is presented. The method may include connecting, via a drain and a source of a JFET, the run input of the circuit to electrical ground. The method may include connecting a gate of the JFET to a voltage supply, wherein the voltage supply has an on state and an off state. The method may include triggering the voltage supply in the off state. The method may include triggering the JFET to electrically connect the run input of the circuit with electrical ground, wherein triggering the JFET comprises floating or coupling to ground the gate of the JFET. The method may include connecting the run input of the circuit with electrical ground via the source and drain of the JFET. The method may include triggering the voltage supply in the on state to apply a voltage to the gate of the JFET. The method may include triggering the JFET to decouple the run input of the circuit from electrical ground. Triggering the JFET may comprise applying a voltage to the gate of the JFET by the voltage supply. The method may include floating the run input of the circuit.

In some embodiments, a system for controlling operation of a circuit. The system may comprise the circuit. The circuit may comprise a run input, such that the circuit is active when a voltage above a threshold voltage is present at the run input and the circuit is inactive when the run input is coupled with electrical ground. The circuit may be coupled with a supply voltage. The system may comprise the supply voltage, wherein the supply voltage has an on state and an off state. The system may comprise a JFET, comprising a first port, a second port, and a gate. The first port may be coupled with the run input of the circuit. The second port may be coupled with electrical ground. The gate may be coupled with the supply voltage. The JFET may connect the run input of the circuit with electrical ground when the supply voltage is in the off state. The JFET may decouple at least one current path of the run input of the circuit from electrical ground when a voltage is present at the gate of the JFET.

### BRIEF DESCRIPTION OF THE DRAWINGS

FIG. 1 illustrates a simplified block diagram of an embodiment of a crowbar circuit.

FIG. 2 illustrates a simplified block diagram of an embodiment of a JFET crowbar circuit.

FIG. 3 illustrates a circuit diagram of an embodiment of a JFET crowbar circuit.

FIG. 4 illustrates an embodiment of a method for controlling operation of a circuit having a run input.

FIG. 5 illustrates an embodiment of a method for using a JFET crowbar circuit to control operation of a regulator controller.

### DETAILED DESCRIPTION OF THE INVENTION

A weakness of the circuits described in the Background when applied to battery charging may be that a battery powers the regulator through parasitic diodes in the switching FETs such that the regulator runs though its intended power source is absent. This can cause serious damage to the circuit. Controls to prevent such damage require a power source. If the controls are to operate with no external power available, the controls may take power from the battery. Limiting off-state battery drain may be desired, thus the use of such controls may not be desired. Rather, a switch, such as a JFET, that is closed when no power supplied to it may be used. A relay may not be cheap or compact enough. For negative ground circuits, a P-Channel junction FET connected drain to source across the input to be shunted, and with its gate connected to the voltage source that must be present when the protected function is to be enabled. For positively grounded circuits, an n-Channel JFET may be used.

A p-channel JFET (junction-gate field-effect transistor) may be used to create a circuit that disables another circuit, such as a regulator controller, when the regulator controller does not have a supply voltage present. Disabling a circuit may be necessary, if the circuit is not coupled with a voltage source, because the circuit may be powered through parasitic paths from some other voltage source. This may especially be a consideration in circuits having batteries. In some embodiments detailed herein, a drain of a p-channel JFET is coupled with a run control input of a circuit, such as a regulator controller. The source of the JFET may be coupled with electrical ground. The gate of the JFET may be coupled with the supply voltage that also (at least partially) powers the regulator controller. Therefore, when the supply voltage is present, the JFET may be open, thereby decoupling the run input of the regulator controller from ground. When the supply voltage is not present, the JFET may be closed, thus creating an electrical connection between the run input of the regulator controller and electrical ground. Such a use of a JFET may be referred to as a JFET crowbar circuit. Such a use of a JFET may be in contrast to the typical use of a p-channel JFET: typically, a p-channel JFET may have its source coupled with a positive voltage, its drain at a lower voltage, and its gate at or above the voltage potential present at the source.

The run input of a regulator controller may be coupled with a current source pull-up. Therefore, a typically small amount of current may be output by the run input. If electrical ground is electrically coupled with the run input, no (or only a small) voltage potential may develop on the run input and the regulator controller may be disabled. However, if an open circuit is present, a potential may develop on the run input, the voltage level on the run input may rise above some threshold voltage level, and the regulator control may be enabled. In some embodiments, such as embodiments where a circuit besides a regulator controller is being controlled, a resistor pull-up may be present instead of a current source pull-up.

One situation where it may be important to disable a regulator controller is in the charging circuitry for a battery pack. A regulator controller may be used to step down or step up a voltage supplied to the regulator controller in order to apply charge to the battery. However, if the voltage being stepped down or stepped up is absent but other conditions allow the regulator controller to operate, damage may result to the regulator controller and/or other circuitry. Further, in the context of battery packs, limited power and space may be available for circuitry to function in conjunction with the regulator controller. Therefore, it may be beneficial to use circuitry that needs no supply voltage to prevent false activation of the circuit it protects, is power efficient (whether on or off), reliable (in that the regulator controller is only enabled when the proper power conditions are present), and occupies little space. As those with skill in the art will recognize, systems besides battery packs may exist that may benefit from such control of a regulator controller, or some other circuit (e.g., an IC) that has a run, reset, enable, or disable input. Further, such a use of a JFET may control devices besides regulator controllers. For example, other circuits that have a run input which may be able to be controlled by such a use of a JFET includes microprocessors, control circuits, and programmable logic devices to name only a few examples.

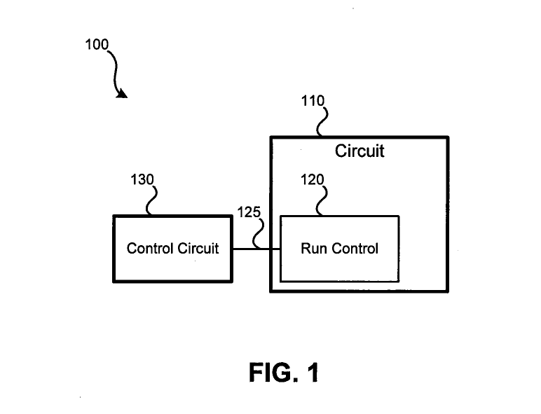

FIG. 1 illustrates an embodiment of a simplified block diagram of a crowbar circuit 100. In some embodiments of crowbar circuit 100, three components are present: a circuit 110, a run control 120 (of circuit 110), and a control circuit 130. In some embodiments of crowbar circuit 100, circuit 110 may be an integrated circuit (IC). One possible type of IC is a regulator controller, such as a switching regulator controller. A switching regulator controller may be a form of a step-down switching regulator controller that can step-down voltages from some higher voltage input. One possible regulator controller is the LTC3703-5 60V Synchronous Switching Regulator Controller available from LINEAR TECHNOLOGY. Besides regulator controllers, circuit 110 may be some other type of circuit.

Circuit 110 may have, as part of circuit 110 or external to circuit 110, run control 120. Run control 120 may control whether circuit 110 is enabled or disabled. In some embodiments, run control 120 may enable and disable only portions or certain functions of circuit 110. Run control 110 may require that an open circuit be present on an input (referred to as run input 125) in order to enable circuit 110. Run control 120 may also require the run input be coupled with electrical ground to disable (some or all of) circuit 110. Run control 120 may emit an amount of current via run input, such as four microamperes.

Control circuit 130 may connect the run input of run control 120 to either electrical ground or may leave the run input open depending on whether circuit 110 is desired to be enabled or disabled. Control circuit 130 may include a JFET. The JFET may be a p-channel JFET. In the case of control circuit 130 including a JFET, depending on whether no voltage or a positive voltage is present on the gate of the JFET, the input of run control 120 may be floating or coupled with electrical ground. In addition to the JFET, other forms of circuitry may be used for control circuit 130. The JFET ensures that run control 120 cannot be enabled unless the monitored supply voltage is present, regardless of the state of control circuit 130 and regardless of whether supply voltage is present or not.

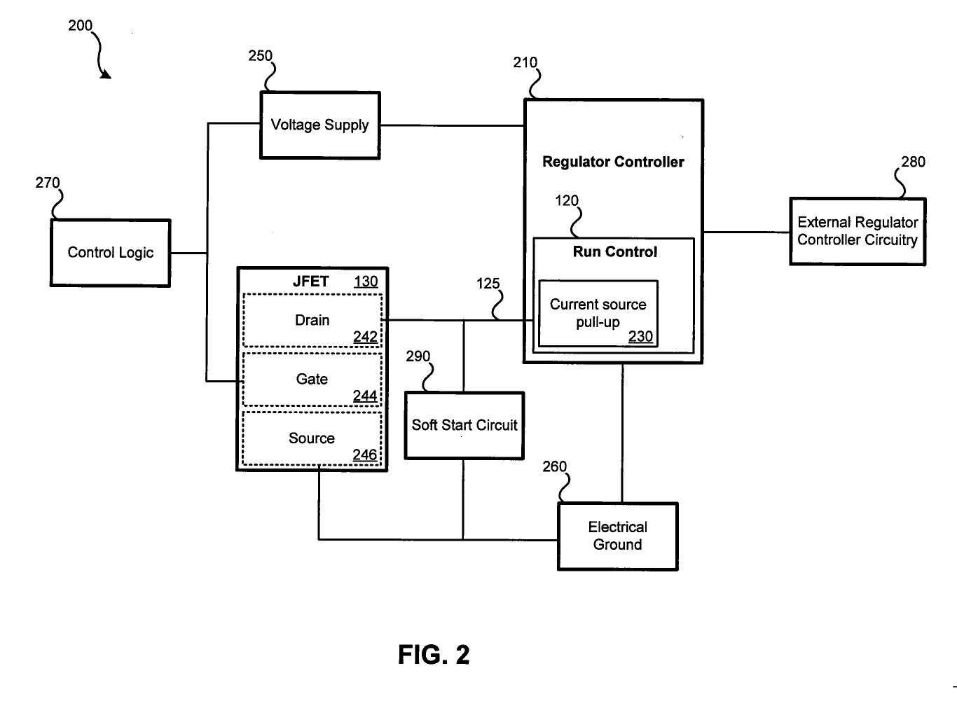

FIG. 2 illustrates a simplified block diagram of an embodiment of a JFET crowbar circuit 200. JFET crowbar circuit 200 may represent the same system as crowbar circuit 100 of FIG. 1. Alternatively, JFET crowbar circuit 200 may represent some other system that uses a crowbar circuit. JFET crowbar circuit 200 may include: regulator controller 210, voltage supply 250, control logic 270, JFET 130, electrical ground 260, external regulator control circuitry 280, and soft start circuit 290.

Regulator controller 210 may represent circuit 110 of FIG. 1, or may represent some other type of circuit. Regulator controller 210 may be a switching regulator controller or some other form of regulator controller. Regulator controller may include a run control module 120. Run control module 120 may be a subcircuit of regulator controller 210. Run control module 120 may determine whether some or all of regulator controller 210 is enabled or disabled depending on an input received by run control module 120. Regulator controller 210 is illustrated in FIG. 2 as having three connections: a connection with voltage supply 250, an input (run input 125) to run control module 120, and a connection with electrical ground 260. As those with skill in the art will recognize, regulator controller 210 may have more inputs and outputs.

Run control module 120 may include current source pull-up 230. Current source pull-up 230 may allow run control module 120 and/or regulator controller 210 to determine whether run input 125 is floating or coupled with electrical ground 260. Current source pull-up 230 may supply an amount of current, such as four microamperes, via run input 125. If run input 125 is floating, a voltage may develop on run input 125 that triggers run control 120 to enable some or all of regulator controller 210. If run input 125 is coupled with electrical ground 260, no voltage (or only a small voltage) may develop on run input 125. This may trigger run control 120 to disable some or all of regulator controller 210.

Regulator controller 210 may be coupled with voltage supply 250. Voltage supply 250 may serve as V_{CC} for regulator controller 210. Voltage supply 250 may be an external voltage supply or may be a battery. In some embodiments, regulator controller 210 may step down some other voltage supplied to regulator controller 210 besides the voltage from voltage supply 250. Voltage supply 250 may have two states: an on state and an off state. In the on state, voltage supply 250 may generate a voltage at or near its intended output voltage (such as 5 V). In its off state, no voltage may be generated by voltage supply 250. Note, that because voltage supply 250 is in an off state and is not generating a voltage, this does not mean that the input voltage to regulator controller that is being stepped down is not present.

In JFET crowbar circuit 200, JFET 130 may control run input 125. JFET 130 may represent control circuit 130 of FIG. 1. JFET 130, which may be a p-channel JFET, may contain: drain 242, gate 244, and source 246. Drain 242 may be coupled with run input 125. Source 246 may be coupled with electrical ground 260. Gate 244 may be coupled with voltage supply 250. As such, when voltage supply 250 is in its on state and is supplying a voltage to regulator controller 210, voltage supply 250 may also be creating a voltage on gate 244. Conversely, when voltage supply 250 is not supplying a voltage to regulator controller 210, voltage supply 250 may not be creating a voltage on gate 244 of JFET 244.

When a voltage is present on gate 244, this may cause JFET 130 to be open, thus electrically decoupling drain 242 from source 246. With drain 242 decoupled from source 246, run input 125 may be floating. Therefore, if voltage supply 250 is in the on state, run input 125 may be floating, thus enabling regulator controller 210. When a voltage is not present on gate 244, JFET 130 may be closed. When JFET 130 is closed, drain 242 and source 246 may be coupled with little or no voltage drop between run input 125 and electrical ground 260. This connection between run input 125 and electrical ground 260 may disable regulator controller 210. Therefore, if voltage supply 250 is in the off state, run input 125 may be coupled with electrical ground, thus disabling regulator controller 210. While JFET 130 is illustrated as having drain 242 coupled with run input 125 and source 246 coupled with electrical ground 260, it may be possible to connect source 246 to run input 125 and drain 242 to electrical ground 260. JFETs have a symmetrical drain and source, such that operation is the same whether the drain or the source is connected to ground and the other terminal is connected to run input 125.

In some instances it may be desirable to enable or disable regulator controller 210 at times determined by conditions other than the on and off state of voltage supply 250. To accomplish this, control logic 270 may be used. Control logic 270 may include one or more transistors, such as MOSFETs that may be used to control whether a voltage is applied to gate 244 or not. Control logic 270 may receive one or more inputs from other circuitry, possibly originating from a user or processor. For instance, while voltage supply 250 may be in its on state and supplying a voltage to regulator controller 210, control logic 270 may connect gate 244 with electrical ground, thus connecting run input 125 to ground and disabling some or all of regulator controller 210.

Regulator controller 210 may also be coupled with external regulator controller circuitry 280. External regulator controller circuitry 280 may include resistors, capacitors, inductors, diodes, MOSFETS, and/or other electronic components that function in conjunction with regulator controller 210 to generate and control the step down voltage created by regulator 210. For instance, a manufacturer of regulator controller 210 may provide a required or recommended circuit diagram of how such external regulator controller circuitry may be coupled with regulator controller 210. The configuration or values of the external regulator controller circuitry 280 may be varied to achieve different output from regulator controller 210.

Soft start circuit 290 may also be present in JFET crowbar circuit 200. Soft start circuit 290 may maintain a connection between run input 125 and electrical ground 260 for a period of time after the current path through JFET 130 has been opened by voltage supply 250 entering its on state. In some embodiments, soft start circuit 290 may include a capacitor. The capacitance of the capacitor (in conjunction with the amount of current emitted by current source pull-up 230 and the threshold enable/disable voltage of regulator controller 210) may determine the period of time between when voltage supply 250 enters its on state and when regulator controller 210 becomes enabled. If soft start circuit 290 is not present, regulator controller 210 may become enabled almost immediately after voltage supply 250 enters its on state. In addition to using a capacitor as soft start circuit 290, it may be possible to use other types of soft start circuits.

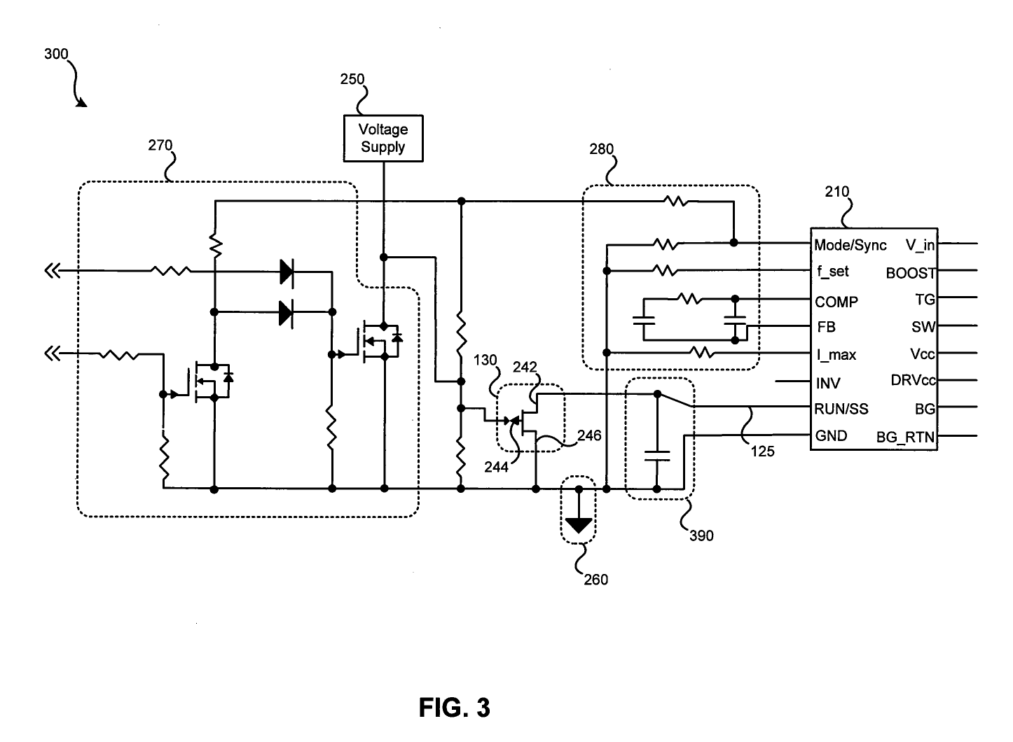

FIG. 3 illustrates a circuit diagram of an embodiment of a JFET crowbar circuit 300. JFET crowbar circuit 300 may represent JFET crowbar circuit 200 of FIG. 2, or may represent some other JFET crowbar circuit.

Regulator controller 210 may represent regulator controller 210 of FIG. 2 or may represent some other regulator controller. In some embodiments, regulator controller 210 is the LTC3703-5 60V Synchronous Switching Regulator Controller available from LINEAR TECHNOLOGY. Regulator controller 210 may have sixteen pins that serve as inputs and outputs. Regulator controller 210 may have separate inputs (which may include connections to external regulator controller circuitry) for V_{CC} and V_{IN}, where V_{IN} may represent the voltage to be stepped down by regulator controller 210.

External regulator controller circuitry 280 may represent external regulator controller circuitry 280 of FIG. 2. External regulator controller circuitry 280 may represent circuitry as recommended or required by the manufacturer of regulator controller 210 for proper functionality.

JFET 130 may represent JFET 130 of FIG. 2. Likewise, drain 242, gate 244, and source 246 may represent drain 242, gate 244, and source 246 of FIG. 2, respectively. JFET 130 may be a p-channel JFET. Drain 242 may be coupled with the run input of regulator controller 210. Source 246 may be coupled with electrical ground 260. Gate 244 may be coupled with voltage supply 250. Voltage supply 250 may also be coupled with the V_{CC} input of regulator controller 210.

Control logic 270 may represent the same control logic as control logic 270 of FIG. 2. In FIG. 3, control logic 270 includes two MOSFETs, two diodes, and several resistors. Control logic 270 may receive two inputs. These inputs are used to determine whether JFET 130 connects run input 125 to electrical ground, or allows run input 125 to float. In other embodiments, control logic 270 may have a different number of inputs.

In addition to run input being coupled with electrical ground via JFET 130, run input 125 may be coupled with electrical ground via soft start circuit 390. Soft start circuit 390 may represent soft start circuit 290 of FIG. 2. Soft start circuit 390, which may comprise a capacitor, may allow for regulator controller 210 to undergo a soft start when JFET 130 is open (e.g., there is a voltage present on gate 244 from voltage supply 250). A soft start may control the amount of time that passes between when an enable signal is applied to regulator controller 210 through control logic 270 and when regulator controller 210 enables and/or ramps up the output voltage of regulator controller 210. Regulator controller 210 may include a current source pull-up. The current source pull-up may source a current, such as four microamperes, from run input 125. Therefore, after voltage supply 250 begins providing voltage to regulator controller 210, run input 125 may remain coupled with electrical ground (despite JFET 130 being open) until capacitor 390 is charged. If a 100 nF capacitor is coupled with run input 125 and electrical ground, and the current source pull-up sources four microamperes, approximately 75 ms after receiving power from voltage supply 250, regulator controller 210 may be enabled. Regulator controller 210 may become enabled after this amount of time because a voltage at or above a threshold voltage level is present on run input 125, such as 0.9 V. If capacitor 390 is not present, regulator controller 210 may be enabled almost immediately after voltage source 250 enters its on state. Therefore, JFET 130 may be used without soft start circuit 390, but may also be used in conjunction with soft start circuit 390.

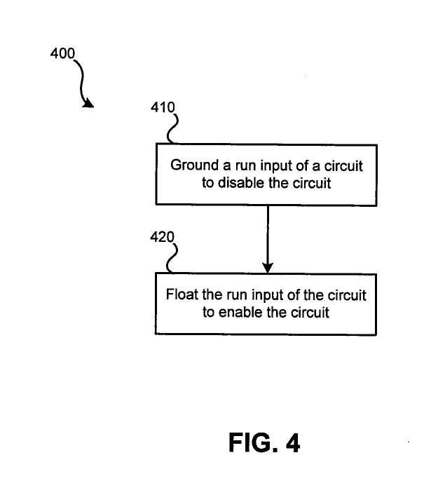

The circuits described in FIGS. 1-3 may be used to perform various methods of controlling the run input of circuits, such as regulator control circuits. FIG. 4 illustrates a method 400 for controlling operation of a circuit having a run input. Method 400 may be performed using the circuits described in relation to FIGS. 1-3, or may be performed using other circuits.

At block 410, a run input of a circuit may be grounded. This circuit may be a regulator controller, such as a switching regulator controller, that has a run input. This run input may require being grounded when the regulator controller is desired to be disabled and being floated when the run input is desired to be enabled. This may occur via a current path through the drain and source of a transistor, such as a p-channel JFET. The run input may also remain electrically grounded for a period of time after the JFET has been opened via a current path through a soft start circuit, such as a capacitor as it charges. While grounded, the output, or other functionality of the circuit having the run input, may be disabled.

At block 420, the run input of the circuit may be floated to enable the circuit. Floating the run input may be accomplished by electrically decoupling the run input from electrical ground (and/or any other voltage or current sources). This may involve a transistor, such as a p-channel JFET, being open, and/or a capacitor being charged to the point of not conducting current from the run input to electrical ground.

It should be understood that an n-channel JFET may be used in a similar way if the circuit employing the n-channel JFET is positively grounded, as opposed to negatively grounded. With an n-channel JFET, a negative voltage may be applied to the gate, by a voltage source that supplies a negative voltage. Applying a negative voltage to the gate of the n-channel JFET would resulting in either the drain or source of the n-channel JFET connected with the run input of the regulator controller floating.

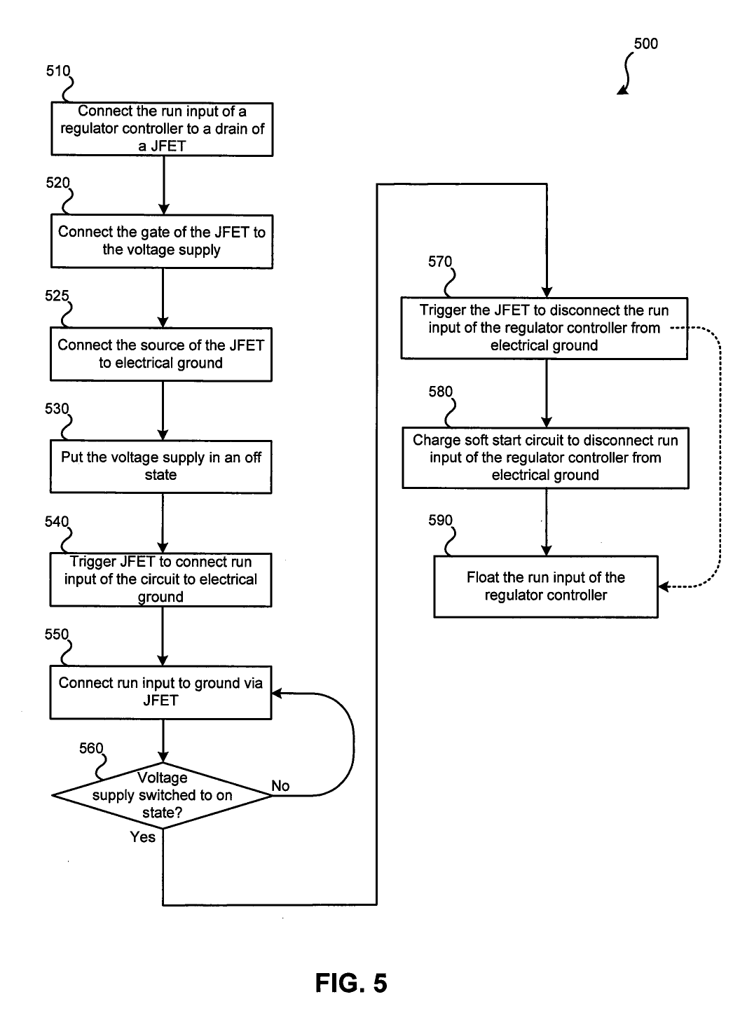

FIG. 5 illustrates an embodiment of a method 500 for using a JFET crowbar circuit to control operation of a regulator controller. Method 500 may be performed using the circuits described in relation to FIGS. 1-3, or may be performed using some other circuit. At block 510, the run input of a regulator controller, such as a synchronous switching regulator controller, may be coupled with the drain of a JFET. This JFET may be a p-channel JFET.

At block 520, the gate of the JFET may be coupled with the voltage supply. This voltage supply may also serve as the voltage supply of the regulator controller. At block 525, the source of the JFET may be coupled with electrical ground.

At block 530, the voltage supply may be put in an off state. In the off state, the voltage supply may not be outputting a voltage. At block 540, the voltage supply being in the off state may result in no voltage (or only an insignificant voltage) being present on the gate of the JFET. This lack of a voltage present at the gate of the JFET may trigger the JFET to close. At block 550, the closed JFET may allow for a current path from the drain to the source of the JFET. Accordingly, since the drain of the JFET is coupled with the run input and the source of the JFET is coupled with electrical ground, the run input of the regulator controller may be coupled with electrical ground.

At block 560, as long as the voltage supply remains in the off state, the run input may remain coupled with electrical ground. If the voltage supply is switched to the on state, the method may continue to block 570. At block 570, the voltage supply may trigger the JFET to open (by placing a voltage on the gate of the JFET), thereby decoupling the run input of the regulator controller from electrical ground (if the current path through the JFET is the only current path between the run input and electrical ground. If no soft start circuit is present, the method may proceed to block 590. If a soft start circuit is present, the method may proceed to block 580.

At block 580, if a soft start circuit is present, the triggering of the JFET to open may not immediately result in the input of the regulator controller being decoupled from electrical ground. Rather, the soft start circuit may impose some period of time delay before the run input of the regulator controller is left floating. For example, if the soft start circuit is a capacitor, the capacitor may be charged by current emitted by the run input of the regulator controller before the run input floats. The period of time delay may be determined by the capacitance of the capacitor, the amount of current emitted by the run input and/or the threshold voltage to enable/disable the regulator controller. At block 590, the run input of the regulator controller may be floating, thus enabling the regulator controller.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

While the above description focuses on the use of a JFET to control regulator controllers, other circuits that have a run input may be able to be controlled by such a use of a JFET. These other circuits include microprocessors, control circuits, and programmable logic devices, to name only a few examples.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A system for controlling operation of a regulator controller integrated circuit, the system comprising:
the regulator controller integrated circuit comprising a run input and a voltage supply input;
a voltage supply, wherein:
the voltage supply has an on state and an off state; and
the voltage supply is coupled with the voltage supply input of the regulator controller integrated circuit; and
a JFET, comprising: a source, a drain and a gate, wherein:
the source of the JFET is coupled with electrical ground,
the drain of the JFET is coupled with the run input of the regulator controller integrated circuit and
the gate of the JFET is coupled with the voltage supply.

2. The system of claim 1, wherein:
the regulator controller integrated circuit is enabled when the run input is floating; and
the regulator controller integrated circuit is disabled when the run input is coupled with electrical ground.

3. The system of claim 1, wherein the JFET is further configured such that the JFET couples the run input of the regulator controller integrated circuit to electrical ground when the voltage supply is in the off state.

4. The system of claim 1, wherein the regulator controller integrated circuit is a switching regulator controller integrated circuit.

5. The system of claim 1, further comprising a soft start circuit coupled with the run input of the regulator controller integrated circuit.

6. The system of claim 1, wherein the JFET decouples a current path from the run input of the regulator controller integrated circuit to electrical ground when the voltage supply is in the on state.

7. The system of claim 1, wherein the regulator controller integrated circuit comprises a current source pull-up coupled with the run input.

8. The system of claim 1, wherein the JFET is a p-channel JFET.

9. The system of claim 1, wherein the JFET is an n-channel JFET, electrical ground is positive, and the voltage supply supplies a negative voltage.

10. A method for controlling operation of a regulator controller integrated circuit having a run input, the method comprising:
coupling, via a drain and a source of a JFET, the run input of the circuit to electrical ground;
coupling a gate of the JFET to a voltage supply, wherein the voltage supply has an on state and an off state;
triggering the voltage supply in the off state;
triggering the JFET to electrically couple the run input of the circuit with electrical ground, wherein triggering the JFET comprises floating or coupling to ground the gate of the JFET;
coupling the run input of the circuit with electrical ground via the source and drain of the JFET;
triggering the voltage supply in the on state to apply a voltage to the gate of the JFET;
triggering the JFET to decouple the run input of the circuit from electrical ground, wherein triggering the JFET comprises applying a voltage to the gate of the JFET by the voltage supply; and
floating the run input of the circuit.

11. The system of claim 10, wherein the regulator controller integrated circuit is a synchronous switching regulator controller.

12. The method of claim 10, further comprising triggering, by control logic, while the voltage supply is in the on state, the JFET to electrically couple the run input of the circuit to electrical ground.

13. The method of claim 10, wherein the circuit comprises a current source pull-up coupled with the run input.

14. A system for controlling operation of a circuit, the system comprising:
the circuit, wherein:
the circuit comprises a run input, such that the circuit is active when a voltage above a threshold voltage is present at the run input and the circuit is inactive when the run input is coupled with electrical ground; and
the circuit is coupled with a supply voltage;
the supply voltage, wherein the supply voltage has an on state and an off state;
a JFET, comprising a first port, a second port, and a gate, wherein:
the first port is coupled with the run input of the circuit;
the second port is coupled with electrical ground; and
the gate is coupled with the supply voltage;
the JFET couples the run input of the circuit with electrical ground when the supply voltage is in the off state; and
the JFET decouples at least one current path of the run input of the circuit from electrical ground when a voltage is present at the gate of the JFET.

15. The system of claim 14, wherein the circuit is a regulator controller integrated circuit.

16. The system of claim 14, wherein the circuit comprises a current source pull-up coupled with the run input.

17. The system of claim 14, further comprising a soft start circuit, wherein:
the soft start circuit comprises a capacitor; and
the soft start circuit couples the run input of the circuit to electrical ground for a period of time when the supply voltage is in the on state.

18. The system of claim 14, further comprising control logic, wherein the control logic is configured to determine whether the voltage is present at the gate of the JFET.

19. The system of claim 18, wherein the first port is the source of the JFET.

20. The system of claim 18, wherein the JFET is a p-channel JFET.
